(19) United States
(12) Patent Application Publication
(10) Pub. No.: US 2001/0052500 A1
(43) Pub. Date: Dec. 20, 2001

(54) Metal removal system and method for chemical mechanical polishing

(75) Inventors: Lizhong Sun, San Jose, CA (US); Fred C. Redeker, Fremont, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 09/882,647

(22) Filed: Jun. 15, 2001

Related U.S. Application Data
(60) Provisional application No. 60/211,780, filed on Jun. 15, 2000.

(51) Int. Cl. C02F 1/62

(52) U.S. Cl. 210/729; 210/205; 210/912

(57) ABSTRACT

An apparatus and method for removing a metal residue from a process waste stream. In one aspect, an apparatus for a waste stream treatment assembly is provided which includes a waste stream metal removal reactor having at least one inlet and at least one outlet, a fluid delivery system connected to the at least one inlet of the waste stream metal removal reactor and a chelating agent supply source, and a filtering member disposed in communication with the at least one outlet of the waste stream metal removal reactor. In another aspect, a method is provided which includes adding a chelating agent to a process waste stream to form a metal complex, and removing the metal complex from the process waste stream prior to disposal.

### CROSS-REFERENCE TO RELATED APPLICATIONS

This application claims benefit of U.S. provisional patent application Ser. No. 60/211,790, filed Jun. 16, 2000, which is herein incorporated by reference.

### BACKGROUND OF THE INVENTION

1. Field of the Invention

Aspects of the invention relate to a system and method of removing metal residue from a waste stream.

2. Background of the Related Art

In the fabrication of integrated circuits and other electronic devices, multiple layers of conducting, semiconducting, and dielectric materials are deposited on or removed from a surface of a substrate. Thin films of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and now electro-chemical plating (ECP).

As a series of layers are sequentially deposited and removed, the uppermost surface of the substrate may become non-planar across its surface and require planarization. Planarization is a “polishing” process to remove topography or surface defects such as a crystal lattice damage, scratches, roughness, or embedded particles such as dirt or dust. Mechanical planarization or chemical mechanical planarization (CMP) are common substrate “polishing” techniques. CMP utilizes a chemical slurry or other fluid medium to facilitate removal of material from substrates and to provide selectivity between films on the substrate surface, and is referred to as a wet process.

A wet process utilizes one or more fluid compositions to effect material deposition on or removal from a surface of a substrate. In addition to CMP, wet processes also include electrochemical plating, and spin-on deposition techniques. Electro-chemical plating utilizes an electrolyte solution containing charged metal ions to deposit a metal film to a surface of a substrate. Spin-on deposition processes utilize precursors that form a film on a substrate. The precursors are delivered on a substrate and evenly disposed by rotation of the substrate.

One problem encountered in a wet process is the production of a waste stream containing heavy metal residue that must be discarded as industrial waste. For example, in CMP, the waste stream may contain heavy metals removed from a surface of a substrate, such as copper, nickel, titanium, and tungsten, for example. In electroplating, the waste stream may contain similar heavy metals from a spent or depleted electrolyte solution.

Heavy metals are generally elements having atomic numbers greater than 20, as defined by the Periodic Chart of the Elements and are metallic at ambient conditions. Heavy metals present the potential of adverse effects on health and the environment. As such, the Environmental Protection Agency (EPA) sets forth regulatory guidelines for heavy metal concentration in a discarded waste stream. For example, the EPA requirement for copper concentration in a discarded waste stream is 0.4 parts per million (ppm).

A goal of all modern processing is to provide environmentally friendly processes. Therefore, there exists a need for an efficient and cost effective method and apparatus to substantially remove metal residue from a wet process waste stream to meet or exceed the Environmental Protection Agency (EPA) guidelines.

### SUMMARY OF THE INVENTION

Aspects of the invention generally provide an apparatus and method for removing conductive material residue, such as metal residue from electroplating and chemical mechanical polishing processes from process waste streams. In one aspect, a method is provided for treating a process waste stream including adding a chelating agent to a process waste stream containing a metal residue to form a metal complex with at least a portion of the metal residue, and removing the metal complex from the process waste stream.

In another aspect, a method is provided for chemical mechanical polishing a substrate including providing a substrate having a substrate surface comprising a conductive material, removing the conductive material from the substrate surface with a polishing pad and a fluid composition, collecting a conductive material residue in a waste stream, adding a chelating agent to the waste stream to form an insoluble metal complex with at least a portion of the conductive material residue, and separating the metal complex from the waste stream.

In still another aspect, an apparatus for a waste stream treatment assembly is provided. The apparatus includes a waste stream metal removal reactor having at least one inlet and at least one outlet, a fluid delivery system connected to the at least one inlet of the waste stream metal removal reactor and a chelating agent source supply, and a filtering member disposed in communication with the at least one outlet of the waste stream metal removal reactor.

### BRIEF DESCRIPTION OF THE DRAWINGS

So that the manner in which the above recited aspects invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic perspective view of a chemical mechanical polishing apparatus.

FIG. 2 is a cross-sectional view of a platen of FIG. 1.

FIG. 3 is a schematic view of a metal residue removal system.

### DETAILED DESCRIPTION OF THE PREFERRED EMBODIMENT

Aspects of the invention generally provide a cost effective and efficient apparatus and method for removing conductive material residue, residue from a process waste stream such as from a chemical mechanical planarization (CMP) process waste stream or an electrochemical deposition stream.

In one aspect, a chelating agent is added to a process waste stream that contains conductive material residue, such as metal residues. The chelating agent bonds to metals present in the residue to form insoluble metal complexes that precipitate from the waste stream. The metal complex solids are then separated from the waste stream by conventional solid removal techniques, such as filtering.

It is believed that the present invention applies to any wet processing system, such as electro-chemical deposition systems and CMP systems, which produces or results in a waste stream having a metal concentration exceeding the Environmental Protection Agency (EPA) guidelines. For simplicity and ease of description, however, the present invention will be described below as it relates to a slurry waste stream from a CMP process. However, the invention contemplates being used in conjunction with waste streams from other manufacturing apparatus, such as electrochemical deposition apparatus, which include electroplating and electroless deposition apparatus.

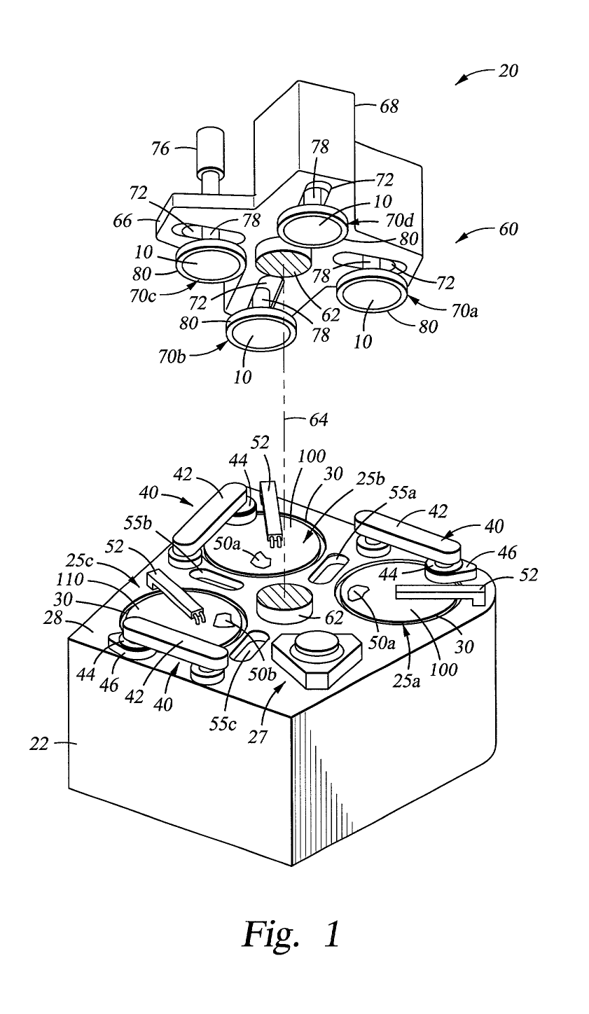

FIG. 1 is a schematic perspective view of a chemical mechanical polishing apparatus 20. The polishing apparatus 20 includes a lower machine base 22 with a table top 23 mounted thereon and a removable outer cover (not shown). The table top 23 supports a series of polishing stations, including a first polishing station 25a, a second polishing station 25b, a final polishing station 25c, and a transfer station 27. The transfer station 27 serves multiple functions, including receiving individual substrates 10 from a loading apparatus (not shown), washing the substrates, loading the substrates into carrier heads 80, receiving the substrates 10 from the carrier heads 80, washing the substrates 10 again, and transferring the substrates 10 back to the loading apparatus. One polishing system that is used to perform CMP is the Mirra® CMP System available from Applied Materials, Inc., located in Santa Clara, Calif., as shown and described in U.S. Pat. No. 5,738,574, entitled, “Continuous Processing System for Chemical Mechanical Polishing,” the entirety of which is incorporated herein by reference.

Each polishing station 25a-25c includes a rotatable platen 30 having a polishing pad 100 or 110 disposed thereon. Each platen 30 may be a rotatable aluminum or stainless steel plate connected to a platen drive motor (not shown). In a typical arrangement, the first and second stations 25a and 25b may include a fixed-abrasive pad 100, and the third polishing station 25c may include a conventional or non-abrasive pad 110.

The polishing stations 25a-25c may include a pad conditioner apparatus 40. The pad conditioner apparatus 40 has a rotatable arm 42 holding an independently rotating conditioner head 44 and an associated washing basin 46. The pad conditioner apparatus 40 maintains the condition of the polishing pad so that it will effectively polish the substrates. The polishing stations 25a and 25b having fixed-abrasive pads disposed thereon do not require the pad conditioner apparatus since fixed-abrasive pads generally do not require conditioning. However, as illustrated, each polishing station may include a conditioning station if the CMP apparatus is used with other pad configurations.

The polishing stations 25a-25c may each have a slurry/rinse arm 52 that includes two or more supply tubes to provide a chemical slurry and/or water to the surface of the polishing pad. The slurry/rinse arm 52 delivers the chemical slurry in an amount sufficient to cover and wet the entire polishing pad. Each slurry/rinse arm 52 also includes several spray nozzles (not shown) that can provide a high-pressure fluid rinse of the polishing pad at the end of each polishing and conditioning cycle. Furthermore, two or more intermediate washing stations 55a, 55b, and 55c may be positioned between adjacent polishing stations 25a, 25b, and 25c to clean the substrate as it passes from one station to the next.

The chemical slurry may include a chemical component and de-ionized water when used in conjunction with the fixed-abrasive pad 100, and may include a chemical component and de-ionized water when used in conjunction with the conventional polishing pad 110. However, the chemical slurry generally includes an abrasive component and a chemical component used in conjunction with the conventional polishing pad 110.

A typical metal polishing slurry having an abrasive and chemical component may consist of a colloidal suspension of silicon oxide particles, with an average size of, for example, 50 nm, an oxidizer such as hydrogen peroxide, and a chelating agent such as ammonium oxalate in a solution having a pH from about 2 to about 9. The chelating agent in the metal polishing slurry chemically reacts with metal ions removed from the polished surface to form a soluble metal complex. Abrasive components of the slurry component may include, but are not limited to, silica, alumina, zirconium oxide, titanium oxide, or any other abrasive used in conventional planarization slurries. The above chemical slurry description is illustrative and should not be interpreted or construed as limiting the scope of the invention.

A rotatable multi-head carousel 60 is positioned above the lower machine base 22. The carousel 60 includes four carrier head systems 70a, 70b, 70c, and 70d. Three of the carrier head systems receive or hold the substrates 10 by pressing them against the polishing pads 100 or 110 disposed on the polishing stations 25a-25c. One of the carrier head systems 70a-70d receives a substrate from and delivers a substrate 10 to the transfer station 27. The carousel 60 is supported by a center post 62 and is rotated about a carousel axis 64 by a motor assembly (not shown) located within the machine base 22. The center post 62 also supports a carousel support plate 66 and a cover 68.

The four carrier head systems 70a-70d are mounted on the carousel support plate 66 at equal angular intervals about the carousel axis 64. The center post 62 allows the carousel motor to rotate the carousel support plate 66 and orbit the carrier head systems 70a-70d about the carousel axis 64.

Each carrier head system 70a-70d includes one carrier head 80. A carrier drive shaft 78 connects a carrier head rotation motor 76 (shown by the removal of one quarter of the cover 68) to the carrier head 80 so that the carrier head 80 can independently rotate about its own axis. There is one carrier drive shaft 74 and motor 76 for each head 80. In addition, each carrier head 80 independently oscillates laterally in a radial slot 72 formed in the carousel support plate 66.

The carrier head 80 performs several mechanical functions. Generally, the carrier head 80 holds the substrate 10 against the polishing pad 100 or 110, evenly distributes a downward pressure across the back surface of the substrate 10, transfers torque from the drive shaft 78 to the substrate 10, and ensures that the substrate 10 does not slip out from beneath the carrier head 80 during polishing operations.

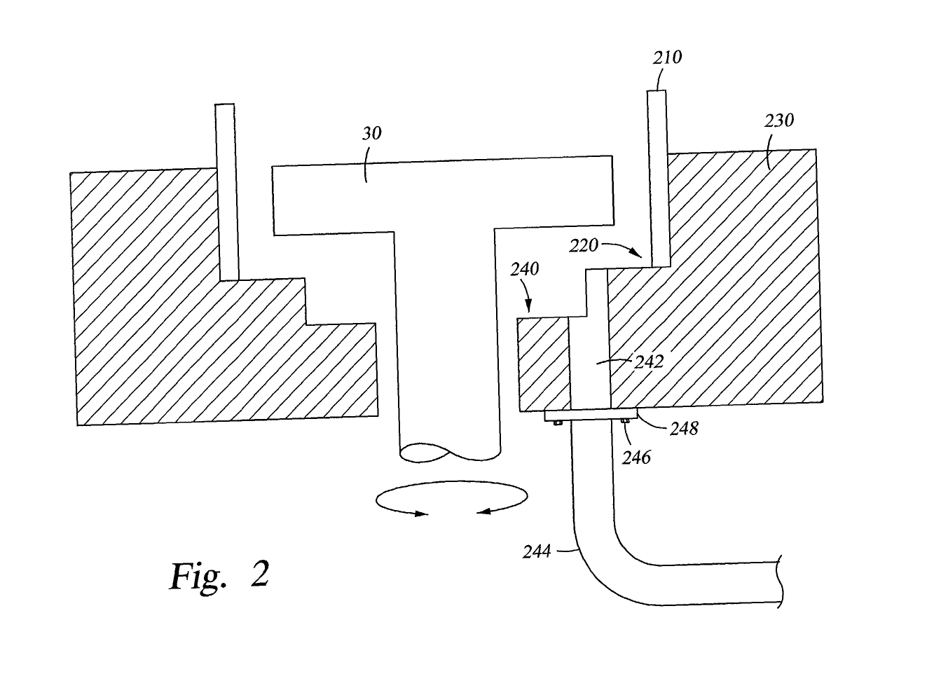

FIG. 2 is a cross-sectional view of the tabletop and platen of FIG. 1. A circular fence 210 surrounds the rotating platen 30 and captures slurry waste centrifugally expelled from the platen 30. The slurry waste stream includes conductive material removed from processed substrates. The removed conductive material may include metal ions or metal residue, such as copper, nickel, aluminum, tungsten, titanium, and ions and residue of semi-conductive material, such as silicon.

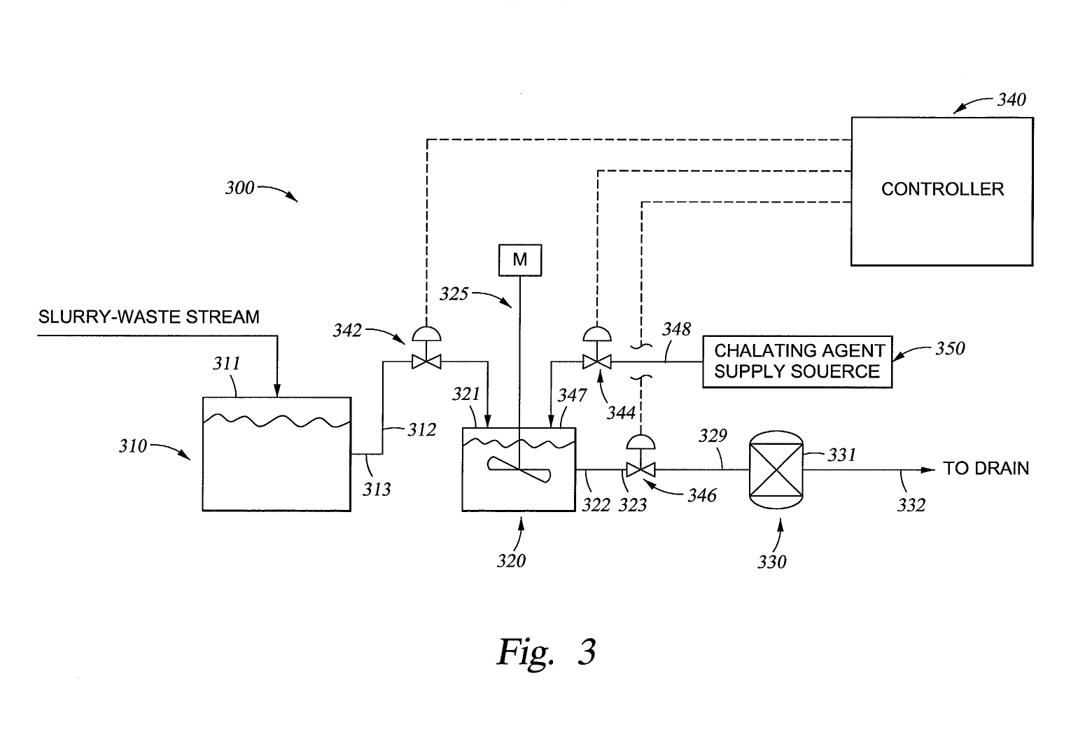

The slurry waste stream from the platen 30 flows down to a trough 220 formed in the table top 230 and then flows into the drain channel 240. The drain channel 240 comprises a channel 242 in communication with a drain pipe 244 connected to the table top 230 by screws 246 passing through a flange 248 of the drain pipe 244 and threaded into the bottom of the table top 230. The slurry waste from the platen 30 flows under gravity through the channel 242 and through the drain pipe 244 to a metal residue removal system 300 which is shown in FIG. 3 and described below. Alternatively, the slurry waste may be pumped to the metal residue removal system 300.

FIG. 3 is a schematic view of the metal residue removal system 300. The metal residue removal system 300 comprises a waste collection tank 310, a reactor 320, and a filtering device 330. The system may also include a mixing member 325, a plurality of control valves 342, 344, and 346, a controller 340, and conduits 313, 323, and 332 that may be any conventional piping or tubing. The metal residue removal system 300 may be integrated with the CMP apparatus 20. For example, the system may be disposed underneath the tabletop 230. Alternatively, the metal residue removal system 300 may be a stand-alone unit remotely located from the CMP apparatus 20.

The waste collection tank 310 may be any conventional vessel or tank made of a corrosion resistance material such as poly vinyl chloride (PVC), for example. The waste collection tank 310 is typically open to the atmosphere, but may also be a closed container or pressurized vessel. The waste collection tank 310 includes at least one inlet 311 connected to a waste process stream from a substrate processing system. For example, the waste collection tank may include an inlet in fluid communication with an ECP waste stream and/or an inlet in fluid communication with a CMP waste stream. As shown in FIG. 3, the inlet 311 is disposed in fluid communication with the drainpipe 244 of the CMP apparatus 20. The waste collection tank 310 also includes at least one outlet.

As shown in FIG. 3, an outlet 313 is disposed in fluid communication with an inlet 321 of the reactor 320 via the conduit 312. The conduit 312 may include a pump (not shown) and/or the control valve 342 disposed along its length to control the flow of the slurry waste from the waste collection tank 310 to the reactor 320. Similarly, the drainpipe 244 may include a pump and/or a control valve (neither shown) disposed along its length to control the flow of the slurry waste from the CMP apparatus 20 to the waste collection tank 310.

The reactor 320 may be any conventional vessel or tank made of a corrosion resistance material such as poly vinyl chloride (PVC), for example. The reactor 320 is typically open to the atmosphere, but may also be a closed container or pressurized vessel. The reactor 320 includes at least one inlet and at least one outlet. As shown in FIG. 3, conduit 312 is connected to an inlet 321 to provide fluid communication with the waste collection tank 310. The reactor 320 is also in fluid communication with the filtering device 330 via the conduit 323. The conduit 323 is connected at one end to outlet 322 of the reactor 320 and at the other end, to the inlet 329 of the filtering device 330. The conduit 323 may include a pump (not shown) and/or the control valve 346 disposed along its length to control the flow of the slurry waste from the reactor 320 to the filtering device 330.

The metal residue removal system 300 also includes a conduit 348 disposed to an inlet 347 of the reactor 320. The conduit 348 is connected to a chelating agent supply source 350 to deliver chelating agent to the reactor 320. The conduit 348 may include a pump (not shown) and/or a control valve 344 disposed along its length to control the flow of the chelating agent from the chelating agent source supply 350 to the reactor 320.

The filtering device 330 may be a conventional sand filter, a mixed media filter, or a membrane filter having pore size openings of about 0.1 microns to about 50 microns. Suitable filters can be obtained from any manufacturer of filter devices. Other types of filtration and solids removal methods may also be employed. The filtering device 330 comprises at least one inlet 329 and at least one outlet 331. As shown in FIG. 3 and explained above, the conduit 323 is connected to the inlet 329, placing the filtering device 330 in fluid communication with the outlet 322 of the reactor 320. The filtering device 330 is also in fluid communication with a process drain or alternatively, a recycle system (not shown), via the conduit 332. The conduit 332 may include a pump (not shown) and/or a control valve (not shown) disposed along its length to control the flow of the slurry waste from the filtering device 330 to the process drain or alternatively, the recycle system.

The metal residue removal system 300 may further include a mixing member 325 associated with the reactor 320. For example, the mixing member 325 may be a mixer member, such as a mixer-agitator having a propeller or blade, which is disposed in the reactor 320 to mix the waste stream and the chelating agent. However, any conventional mixing system may be used.

The controller 340 controls the overall operation of the metal residue removal system including the flow rates of the waste stream and chelating agent, the operating pressure of the system, the sequencing of the valves 342, 344, and 346, and the mixing of the solution. The controller 340 may be remotely located in a control panel or control room and controlled with remote actuators. The controller 340 may be fashioned as a microcontroller, a microprocessor, a general-purpose computer, or any other known applicable type of computer. The application integration of programmable controllers is well known and will not be further detailed herein.

In operation, a waste stream flows from the CMP apparatus 20 to the collection tank 310 where the waste stream is stored until a prescribed liquid level within the collection tank 310 is reached. The waste stream then flows by gravity or is pumped (not shown) from the collection tank 310 to the reactor 320. A chelating agent is added to the waste stream in the reactor 320 to form a suspension comprising an insoluble metal complex. The suspension may be mixed, for example, by a mixer member 325, as shown in FIG. 3. Alternatively, the suspension may be mixed by other known methods. The suspension is mixed for about 30 seconds to about 3 minutes, and in one embodiment, the suspension is mixed for about 1 minute. Preferably, the solution is mixed for about 30 seconds.

Generally, the amount of chelating agent added to the waste stream is dependent on the amount of material to be removed from the waste stream. The amount of material in the waste stream is generally dependent on the amount of material removed from the processed substrates. Likewise, the amount of chelating agent added to the waste stream is dependent on the concentration of the metal ions in a spent or used electrolytic solution. Generally, the chelating agent is added in an amount between about 0.001% and about 5.0% by weight (wt. %) of the waste stream. In one embodiment, between about 0.01% by weight and about 0.1% by weight of the waste stream of chelating agent is added to the waste stream. Chelating agents may be added to the waste stream in an amount between about 0.01% by weight and about 0.03% by weight of the waste stream. The invention contemplates the addition of more chelating agent and less chelating agent described above to remove sufficient amounts of conductive material from the waste as required by the operator.

Chelating agents that may be used in the invention include those chelating agents that precipitate as solids from a solution when combining with metal ions. Examples of suitable chelating agents include chelating agents having an amine group, a quinoline group, a nitrogen containing cyclic group, or combinations thereof. One chelating agent useful for aluminum, nickel, and copper metal removal is 8-hydroxyquinoline. Other chelating agents may include benzoylphenylhydroxyamine, bimethylglyoxime, n-nitroso-n-phenylhydroxylamine, “cupral”, or combinations thereof. Bimethylglyoxime is especially useful for nickel removal. Additionally, the invention contemplates the use of additional chelating agents for forming metal complexes with the respective individual metal ions found in the waste stream.

A chelating agent is broadly defined herein, as a chemical agent having donor atoms that combine by coordinate bonding with a metal ion in the waste stream to form a solid metal complex. Generally, the metal complex is insoluble and thus, precipitates from the solution as a solid. Once the metal complex has formed and precipitated from the mixture, the mixture is allowed to flow by gravity or pumped (not shown) through a filtering device 330 to separate the solid metal complex from the fluid mixture. Once the metal complex has been separated, the mixture is discarded as industrial waste. Alternatively, a processed slurry waste stream from a CMP process may be recycled.

Generally, the chelating agents described herein provide the concentration reduction of metal residue to meet or exceed the EPA discharge criteria. The invention contemplates the addition of other chelating agents for metal, such as organic acids and bases for copper, and chelating agents for semiconductive materials such as silicon, that may meet or exceed the EPA discharge criteria. However, the invention also contemplates chelating agents that reduce the concentration of metal residues to the levels desired by the operators. In addition, the method described herein provides for a quick and in-line removal of metal residue from a wet process waste stream, and may be operated in batch or continuously, depending on production requirements.

It is also believed that the waste collection tank 310 may be eliminated and the reactor 320 is used to collect the slurry waste stream from the CMP apparatus 20 and treat the metal residue as explained above. In this embodiment, the drainpipe 244 from the CMP apparatus 20 is disposed in fluid communication with the inlet 321 of the reactor 320. The reactor 320 is also in fluid communication with the filtering device 330, the mixing member 325, and the chelating agent supply source 330, as explained above.

The invention is further illustrated by the following non-limiting example. The example illustrates the result of this invention in preparing a copper CMP slurry waste stream for disposal well below the EPA's 0.4 ppm copper concentration limit by reducing the copper residue concentration of the slurry waste stream to 0.22 ppm in one minute.

### EXAMPLE:

In a buffing container, about 0.01% by weight of 8-hydroxyquinoline was added to a copper CMP slurry waste stream containing 18.3 ppm of copper ions, and mixed by a mixer-agitator for one minute. The resulting suspension was passed through a filter to remove the solid metal complex from the remaining waste stream. The filtered solution was analyzed by Inductive Coupled Plasma analysis (ICP), which showed that the copper residue concentration of the filtered effluent was 0.22 ppm. The EPA requirement for copper concentration in a discarded waste stream is 0.4 parts per million (ppm).

While foregoing is directed to the preferred embodiment of the present invention, other and further embodiments of the invention may be devised without departing from the basic scope thereof, and the scope thereof is determined by the claims that follow.

1. A method of treating a process waste stream, comprising:
adding a chelating agent continuously to a semiconductor manufacturing process waste stream containing a metal residue to form a metal complex with at least a portion of the metal residue, the chelating agent comprising a compound containing an amine group, a quinoline group, a nitrogen containing cyclic group, or combinations thereof; and
removing the metal complex from the process waste stream.

2. The method of claim 1, wherein the metal residue comprises copper, nickel, aluminum, tungsten, titanium, or combinations thereof.

3. The method of claim 1, wherein the metal residue comprises copper and the chelating agent comprises 8-hydroxyquinoline.

4. The method of claim 1, wherein the chelating agent is selected from the group of benzoylphenylhydroxyamine, bimethylglyoxine, n-nitroso-n-phenylhydroxylamine, cupral, 8-hydroxyquinoline, and combinations thereof.

5. The method of claim 1, wherein the chelating agent is added in an amount between about 0.001% by weight and about 5.0% by weight of the waste stream.

6. The method of claim 1, wherein the chelating agent is added in an amount between about 0.01% by weight and about 1.0% by weight of the waste stream.

7. The method of claim 1, wherein the insoluble metal complex is removed by filtering the process waste stream.

8. The method of claim 1, wherein 0.01% by weight of 8-hydroxyquinoline was added to the waste stream to form the metal complex.

9. A method of chemical mechanical polishing, comprising:
providing a substrate having a substrate surface comprising a conductive material;
removing the conductive material from the substrate surface with a polishing pad and a fluid composition;
collecting a conductive material residue in a waste stream;
adding a chelating agent between about 0.001% by weight and about 5.0% by weight of the waste stream to the waste stream to form an insoluble metal complex with at least a portion of the conductive material residue; and
separating the metal complex from the waste stream.

10. The method of claim 9, wherein the insoluble metal complex is separated by filtering the waste stream.

11. The method of claim 9, wherein the metal residue comprises copper, nickel, aluminum, tungsten, and titanium.

12. The method of claim 9, wherein the metal residue comprises copper and the chelating agent comprises 8-hydroxyquinoline.

13. The method of claim 9, wherein the chelating agent comprises a compound having an amine group, a quinoline group, a nitrogen containing cyclic group, or combinations thereof.

14. The method of claim 13, wherein the chelating agent is selected from the group of benzoylphenylhydroxyamine, bimethylglyoxine, n-nitroso-n-phenylhydroxylamine, cupral, 8-hydroxyquinoline, and combinations thereof.

15. The method of claim 9, wherein about 0.01% by weight to about 1.0% by weight of the chelating agent is added to the waste stream.

16. An apparatus for a waste stream treatment assembly, comprising:
a waste stream metal removal reactor having at least one inlet and at least one outlet;
a fluid delivery system connected to the at least one inlet of the waste stream metal removal reactor and a chelating agent supply source; and
a filtering member disposed in communication with the at least one outlet of the waste stream metal removal reactor.

17. The apparatus of claim 16, wherein the waste stream metal removal reactor comprises a mixing member.

18. The apparatus of claim 16, further comprising a waste stream collection member having at least one inlet and at least one outlet wherein the at least one outlet is in communication with the at least one inlet of the waste stream metal removal reactor.

19. The apparatus of claim 18, wherein the at least one inlet of the waste stream collection member is in communication with an electrolyte drain assembly of an electro-chemical deposition system or in communication with a waste drain pipe disposed to a chemical mechanical planarization system.

20. The apparatus of claim 16, wherein the waste treatment assembly is in fluid communication with a chemical mechanical planarization apparatus comprising:
at least one polishing surface;
at least one polishing head rotatably disposed adjacent the polishing surface and movable relative thereto; and
one or more fluid delivery assemblies disposed adjacent the one or more polishing surfaces.
